(19) United States
(12) Patent Application Publication
(10) Pub. No.: US 2026/0284927 A1
(43) Pub. Date: Sep. 24, 2026

(54) METHOD FOR PRODUCING A WOOD-BASED MATERIAL AND WOOD BASED MATERIAL PRODUCTION DEVICE

(71) Applicant: SWISS KRONO Tec AG, Luzern (CH)

(72) Inventors: Julia Borowka, Forst (DE); Joachim Hasch, Berlin (DE); Norbert Kalwa, Horn-Bad Meinberg (DE); Volker Schwind, Berlin (DE)

(21) Appl. No.: 19/479,891

(22) PCT Filed: Apr. 9, 2024
(86) PCT No.: PCT/EP2024/059617

§ 371 Date: Oct. 29, 2025

(30) Foreign Application Priority Data
May 4, 2023 (EP) 23171473.4

(51) Int. Cl. B27N 1/00; B27N 3/02; B27N 3/04; B27N 3/14; B27N 3/18; B27N 3/24

(52) U.S. Cl. CPC B27N 1/003; B27N 3/02; B27N 3/04; B27N 3/14; B27N 3/18; B27N 3/24

(57) ABSTRACT

The disclosure relates to a method for producing a wood-based material in which exhaust air is produced which contains volatile organic substances, especially terpenes and/or aldehydes, and which is released into the environment. The method includes the step of introducing an oxidizing agent into the exhaust air, causing volatile organic compounds contained in the exhaust air to be oxidized, resulting in purified exhaust air.

### FIELD OF INVENTION

The invention relates to a method for producing a wood-based material in which exhaust air is produced which contains volatile organic compounds, especially terpenes and/or aldehydes, and which is released into the environment.

### BACKGROUND

According to a second aspect, the invention relates to a wood-based material production device for producing a wood-based material with (a) a comminution unit for comminuting wood and (b) a dryer for drying comminuted wood, resulting in exhaust air that contains volatile organic compounds, especially terpenes and/or aldehydes.

As described, for example, in EP 2 974 841 A1, wood-based materials are made of wood and used, for example, to manufacture chipboard, OSB panels, wood fiber panels or insulating material. During the production, especially during the drying, of comminuted wood, particularly wood chips or wood fibers, volatile organic compounds (VOC) are released, which pass into the exhaust air. Such VOCs are a burden on the environment, which is why there are limits on the amount of VOCs in the air that cannot be exceeded. Terpenes are especially relevant.

If the material used is wood fiber material, the production of this wood-based material requires large quantities of steam, some of which is diverted and used to heat or boil the wood chips, as is known from U.S. Pat. No. 4,925,527. To prevent volatile organic compounds in the wood from accumulating in the wood-based material, part of the steam is condensed, the terpene-rich components are branched off and the heat released during condensation is used to evaporate water. This process is complex and not very energy-efficient.

US 2007/0081933 discloses a method for removing formaldehyde using hydrogen peroxide, in which terpenes are washed out prior to removing the formaldehyde, for example by means of an alkaline solution.

U.S. Pat. No. 3,882,612 describes a method for reducing the concentration of volatile organic compounds by way of thermal oxidation in air using a high-temperature heat source.

### SUMMARY OF INVENTION

The invention aims to reduce the amount of VOCs in the exhaust air.

The invention solves the problem by way of a method according to the preamble that comprises the step of introducing an oxidizing agent into the exhaust air, thereby oxidizing volatile organic compounds contained in the exhaust air and resulting in purified exhaust air.

The invention also solves the problem by way of a wood-based material production device according to the preamble, said device comprising an exhaust air purifier that is configured to introduce an oxidizing agent into the exhaust air, causing any volatile organic substances contained in the exhaust air to be oxidized and resulting in purified oxidized air.

The advantage of the invention is that specified limits for the release of volatile organic substances into the environment can be maintained within specified limits with comparatively little technical effort.

Within the scope of the present description, an exhaust air purifier is understood to mean a device by means of which a VOC concentration, especially of terpenes and/or aldehydes, can be reduced by at least 50%, particularly at least 70%, by a chemical reaction of the volatile organic compounds with an oxidizing agent. The numbers given are the maximum possible reduction of volatile organic compounds.

Exhaust air is understood to be a mixture of air, possibly particles, possibly gaseous water and possibly liquid droplets, in particular water droplets.

A wood fiber material is understood in particular to mean a wood fiber material that contains lignin. In particular, the method for producing the wood fiber material is carried out during the production of a wood-based material panel, wherein the wood fiber material is used to produce the wood fiber panel.

Specifically, producing the wood-based material does not mean to the burning, pyrolysis or other decomposition of the wood-based material.

The characteristic of introducing the oxidizing agent into the exhaust air, causing the oxidation of volatile organic compounds contained in the exhaust air, is understood particularly to mean that the volatile organic compounds are removed via oxidation. In particular, the volatile organic compounds are not separated by absorption. In particular, the exhaust air develops prior to the processing of the wood-based material, for example to produce a wood-based material panel.

The oxidation agent is preferably an agent for flameless oxidation. According to one embodiment, the oxidizing agent contains oxygen. It is beneficial if the oxidizing agent releases elementary oxygen when it reacts with terpenes and/or aldehydes. In particular, the oxidizing agent is not molecular oxygen; in particular, it is not atmospheric oxygen. In other words, oxidation does not refer to burning. Burning is understood to mean oxidation by means of gaseous oxygen (O₂), especially by means of air.

Preferably, the oxidizing agent is introduced into the exhaust air in such a way that oxidation products resulting from the oxidation of the volatile organic compounds in the exhaust air are released into the exhaust air. This is understood particularly to mean that the oxidation products become part of the exhaust air and are discharged with the exhaust air.

Preferably, the volatile organic compounds are oxidized in the gas phase, for example in liquid droplets. Oxidation preferably does not occur in a liquid phase. According to one embodiment, the oxidizing agent is introduced into the exhaust air in such a way that the terpenes are oxidized in the gas phase. Oxidation in the gas phase is understood particularly to mean that oxidation does not occur on a solid interface of a component of the system used to purify the exhaust air. In particular, this is understood to mean that the oxidizing agent is introduced into the exhaust air in such a way that the particulate terpenes, especially terpene particles, are oxidized in the gas phase, in particular not in the adsorbed state. In particular, the particulate terpenes are oxidized directly, i.e. in an uncatalysed manner.

The oxidizing agent is preferably liquid. For example, the oxidizing agent is hydrogen peroxide. Alternatively, the oxidizing agent is ozone. When a reference is made to hydrogen peroxide, it also refers to an aqueous solution of hydrogen peroxide. The hydrogen peroxide may contain Fe(II) salt, ammonium persulphate, cytochrome P450, monooxygenases or ammonium peroxide. In particular, the oxidizing agent is not molecular oxygen or air.

According to one preferred embodiment, the method comprises the steps (a) heating wood chips in a pre-boiler by means of water or steam, (b) then boiling the wood chips in a boiler by means of steam, and subsequently (c) defibering the wood chips in a refiner, resulting in fiber material and exhaust air. In this case, the exhaust air contains steam or condensed steam, i.e. air with liquid droplets.

Boiling the wood chips is understood particularly to mean that the wood chips are heated with water and/or steam. The wood chips are preferably first introduced into the pre-boiler and then the boiler.

The invention also includes a method for producing a wood fiber panel, in which the above-mentioned method is carried out. A wood fibre panel is understood in particular to mean LDF, MDF or HDF. The fiber material is wood fibers.

The invention also includes a method for producing insulating material or plant substrate for cultivating plants, in which the above-mentioned method is carried out.

The invention also includes a method for producing a chipboard, in which the above-mentioned method is carried out. In this case, the method preferably comprises the steps (a) chipping round timber, wood residues and/or waste wood, resulting in wood chips, (b) drying the wood chips, (c) gluing the wood chips, (d) scattering the glued wood chips and molding them to create a chip mat and (e) pressing the chip mat to produce a chipboard. It is possible that the wood chips are scattered in multiple layers.

The invention also includes a method for producing an OSB panel, in which the above-mentioned method is carried out. In this case, the method preferably comprises the steps (a) chipping round timber, wood residues and/or waste wood, resulting in coarse chips, (b) drying the coarse chips, (c) gluing the coarse chips, (d) scattering the glued coarse chips and molding them to create a chip mat and (e) pressing the chip mat to produce an OSB panel.

It is possible that the coarse chips are scattered in multiple layers. Preferably, the preferred orientation of the coarse chips of at least two adjacent layers differs. For example, the preferred orientation of the second layer is transverse to the preferred orientation of the first layer to which the second layer is applied. For example, if the preferred orientation of the first layer extends along the conveying direction in which the chip mat moves, the preferred orientation of the second layer is preferably transverse to the direction of travel. The preferred orientation is the direction in which the majority of the longitudinal axes of the (elongated) coarse chips extend.

It is beneficial if the concentration of VOC c_{VOC,1}, i.e. the concentration of volatile organic compounds, especially terpenes and/or aldehydes, in the exhaust air is measured. Preferably, the VOC concentration c_{VOC,1} is measured regularly, preferably continuously. For example, the VOC concentration c_{VOC,1} is measured at least once a week, especially at least once a day, especially at least once an hour, especially at least once a minute. For example, the VOC concentration c_{VOC,1} is given in mass per exhaust air volume or in mass fraction of the exhaust air.

The VOC concentration refers to a concentration by means of which the concentration of volatile organic components can be concluded. In particular, the TOC concentration of all organic carbon compounds is also a VOC concentration when it comes to complying with an upper limit. When the VOC concentration is referred to in the following, one could also always refer in general terms to the TOC concentration (TOC=total organic carbon).

Preferably, the introduction of the oxidizing agent into the exhaust air is controlled on the basis of the VOC concentration. In other words, the amount of oxidizing agent in particular, namely the oxidizing agent flow introduced into the exhaust air, increases when the VOC concentration increases. In addition, the amount of oxidizing agent introduced into the exhaust air can be reduced when the VOC concentration decreases. On the one hand, this means that there is always enough oxidizing agent introduced into the exhaust air and, on the other hand, it minimizes the use of oxidizing agent. It is beneficial if this VOC concentration is measured in the direction of exhaust air flow upstream of an introduction point where the oxidizing agent is introduced into the exhaust air. Control may be feedback control based on a predetermined target VOC concentration, but this is not essential.

The introduction of the oxidizing agent into the exhaust air on the basis of the VOC concentration may comprise the detection of a measurement variable from which the VOC concentration can be indirectly determined. For example, the control of the introduction of the oxidizing agent into the exhaust air on the basis of the VOC concentration may also be a control of the introduction of the oxidizing agent into the exhaust air on the basis of an oxidizing agent concentration. The more oxidizing agent measured, the lower the VOC concentration.

The method preferably comprises the steps (a) comparing the VOC concentration c_{VOC,1} with a limit concentration c_{VOC,G} and (b) if the VOC concentration c_{VOC,1} is below the limit concentration c_{VOC,G}, introducing an idle flow of oxidizing agent, in particular no oxidizing agent. This saves oxidizing agent as it is not necessary in order to fall short of the limit concentration c_{VOC,G} in the exhaust air. However, it is possible that an idle flow of oxidizing agent is introduced into the exhaust air, for example in order to quickly increase the oxidizing agent flow when necessary. The idle flow is a volume flow of oxidizing agent that is smaller than the oxidizing agent flow required to reduce the amount of VOC. For example, the idle flow is at most one fifth, especially one tenth, of the flow that is introduced when the limit concentration is exceeded.

If the VOC concentration c_{VOC,1} does not fall below the limit concentration (c_{VOC,G}), an oxidizing agent flow is preferably introduced into the exhaust air, wherein the oxidizing agent flow is selected in such a way that a release VOC concentration (c_{VOC,A}) in the exhaust air which is released into the environment is below a predetermined exhaust air limit concentration c_{VOC,BREV}. The exhaust air limit concentration is, for example, a statutory specification. For example, c_{VOC,BREV}=400 μg/m³ may apply. The volume is preferably measured in standard cubic meters, i.e. the volume of the gas under standard conditions (23° C., 1013 hPa).

According to one embodiment, a second VOC concentration of volatile organic compounds, especially terpenes and/or aldehydes, in the exhaust air is measured. In particular, this is done in the direction of exhaust air flow, downstream of an introduction point where the oxidizing agent is introduced into the exhaust air. Preferably, the introduction of the oxidizing agent into the exhaust air is also or exclusively controlled or regulated on the basis of the second VOC concentration.

For example, if the second VOC concentration exceeds the exhaust air limit concentration c_{VOC,BREV} then, according to one preferred embodiment, the quantity of oxidizing agent (oxidizing agent flow) introduced per time unit is increased. In particular, this even occurs if the first VOC concentration does not change.

According to one preferred embodiment, if the second VOC concentration falls below a predetermined minimum concentration, the oxidizing agent flow is reduced. In particular, this even occurs if the first VOC concentration does not change.

It is possible that only the second VOC concentration is measured, which then does not have to be referred to as the second VOC concentration, but can be referred to generally as the VOC concentration.

According to one preferred embodiment, the method comprises the step of irradiating the oxidizing agent with UV light. With a suitable oxidizing agent, this causes the oxidizing agent to form radicals, for example. If the oxidizing agent is hydrogen peroxide, for example, hydroxyl radicals are formed. These react especially quickly with VOCs.

Preferably, the irradiation of the oxidizing agent with UV light occurs immediately before introduction into the exhaust air. In particular, the distance between a point where the oxidizing agent is irradiated with UV light and the point where the oxidizing agent comes into contact with the branched-off steam for the first time is at most 10 m, especially at most 5 m.

According to one embodiment, the oxidizing agent is introduced into the exhaust air such that the volatile organic compounds react directly with the oxidizing agent. The characteristic that the volatile organic compounds react directly with the oxidizing agent is understood particularly to mean that they react with one another in an uncatalysed manner. In particular, the oxidizing agent reacts with the volatile organic compounds without requiring contact with a solid interface. In particular, the oxidizing agent thus reacts with volatile organic compounds in the gas phase and, in particular, not with volatile organic compounds bound to an interface.

Preferably, the exhaust air has an exhaust air temperature of at least especially at least 40° C. when the oxidizing agent is introduced. The oxidizing agent reacts with the volatile organic compounds more quickly at high temperatures such that lower concentrations of volatile organic compounds can be achieved in the purified steam. However, high exhaust air temperatures mean a loss of energy, meaning that it is beneficial if the exhaust air temperature is at most 80° C.

The exhaust air preferably has a pressure of at least 1.2 bar and/or at most 5 bar.

Preferably, the method comprises the step of drying the wood-based material, especially the wood chips, coarse chips or wood fibers. Exhaust air produced during drying is preferably purified, as described above, by introducing the oxidizing agent before the exhaust air is released into the environment. In particular, the exhaust air into which the oxidizing agent is introduced consists of at least 20 percent by weight, in particular at least 40 percent by weight, preferably at least 60 percent by weight, and preferably at least 80 percent by weight, of exhaust air produced during the drying of the wood-based material.

If the wood-based material is wood chips, coarse chips or wood fibers, the method preferably comprises the step of gluing the wood-based material, especially by means of a blow line. One embodiment provides for the drying of the glued fiber material.

It is beneficial if the method comprises the steps of scattering the fiber material, especially the dried and/or glued fiber material, to form a fiber cake and pressing the fiber cake to produce a wood-based material panel, in particular a chipboard, an MDF, an MDF or HDF panel or an OSB panel. Pressing is performed, for example, by means of a belt press.

A wood-based material production device according to the invention preferably has a flue that is connected to the exhaust air purifier for releasing the purified exhaust gas into the environment.

The exhaust air purifier may have an oxidizing agent tank filled with oxidizing agent, such as hydrogen peroxide. The exhaust air purifier preferably also has a pump for conveying the oxidizing agent to the introduction device. Alternatively or additionally, the exhaust air purifier may comprise an oxidizing agent generator by means of which oxidizing agent can be produced. For example, the oxidizing agent generator may be an ozone generator. Alternatively or additionally, the exhaust air purifier may comprise an oxidizing agent container in which oxidizing agent can be stored. For example, the oxidizing agent container is filled with hydrogen peroxide.

It is beneficial if the wood fiber panel production device comprises a VOC concentration gauge for measuring a (first) VOC concentration of volatile organic compounds, especially terpenes or aldehydes, and/or the overall concentration of organic carbon compounds in the exhaust air upstream of an introduction point in the direction of exhaust air flow where the oxidizing agent is introduced into the exhaust air.

The doser is preferably designed to automatically introduce the oxidizing agent into the exhaust air on the basis of the measured VOC concentration. In other words, the doser controls or regulates the oxidizing agent flow. For example, the doser contains a controllable pump and/or a controllable valve for this purpose.

For example, the VOC concentration gauge comprises a gas chromatograph with a flame ionization detector. The VOC concentration gauge is preferably designed to automatically measure the VOC concentration at regular intervals, for example more frequently than once an hour, especially more frequently than once every half an hour, particularly preferably more frequently than once every 10 minutes.

In one preferred embodiment, the doser is designed to detect the VOC concentration from the VOC concentration gauge and to automatically introduce the oxidizing agent into the exhaust air on the basis of the VOC concentration and the exhaust air flow. In other words, an oxidizing agent volume flow of oxidizing agent that is introduced per time unit into the exhaust air, particularly on the basis of the VOC concentration and possibly the exhaust air flow, is calculated and the oxidizing agent then introduced accordingly.

The wood-based material production device preferably has a first introduction device for introducing the oxidizing agent into the exhaust air at a first introduction point.

It is especially beneficial if the exhaust air purifier is configured to regulate, i.e. feedback control, the VOC concentration to a predetermined VOC target concentration. If the measured VOC concentration deviates from the VOC target concentration, the oxidizing agent volume flow is adjusted in such a way that the measured VOC concentration approaches the VOC target concentration. If the measured VOC concentration is above the VOC target concentration, the oxidizing agent volume flow is increased. If the measured VOC concentration is below the VOC target concentration, the oxidizing agent volume flow is decreased.

According to one preferred embodiment, the wood-based material production device has a second VOC concentration gauge for measuring a second VOC concentration (or a second TOC concentration) in the exhaust air downstream of the introduction point in the direction of exhaust air flow. The doser is preferably configured to automatically introduce the oxidizing agent into the exhaust air on the basis of the first VOC concentration and the second VOC concentration and, possibly, the exhaust air flow. In other words, the doser is designed to control or regulate the oxidizing agent volume flow on the basis of the first and second VOC concentration. It is possible that the wood-based material production device comprises a VOC concentration gauge downstream of the introduction point in the direction of exhaust air flow. In this case, the second VOC concentration gauge can only be referred to as a VOC concentration gauge.

The wood-based material production device preferably has a second introduction device for introducing the oxidizing agent into the exhaust air at a second introduction point downstream of the first introduction point in the direction of exhaust air flow. The second introduction point is preferably downstream of the second VOC concentration gauge. It is beneficial if the exhaust air purifier is configured to control a second oxidizing agent volume flow of oxidizing agent introduced at the second introduction point, depending on the second VOC concentration.

It is especially beneficial if the exhaust air purifier is configured to regulate, i.e. feedback control, the second VOC concentration to a predetermined second VOC target concentration. If the measured second VOC concentration deviates from the second VOC target concentration, the first and/or second oxidizing agent volume flow is adjusted in such a way that the measured second VOC concentration approaches the second VOC target concentration. If the measured second VOC concentration is above the second VOC target concentration, the first and/or second oxidizing agent volume flow increase(s). If the measured second VOC concentration is below the second VOC target concentration, the first and/or second oxidizing agent volume flow is/are reduced. For example, the VOC target concentration is below the exhaust air limit concentration c_{VOC,BREV}.

Preferably, the wood-based material production device comprises a gluing device for gluing the fiber material. A gluing device is understood to mean a device by means of which the fiber material can be glued. The gluing device may also be referred to as a gluer.

The invention also includes a wood-based material panel production device for producing a wood-based material panel that comprises a wood-based material production device according to the invention. The wood-based material panel production device is, for example, a wood fiber panel production device for producing low-density fibreboard (LDF), medium-density fibreboard (MDF) and/or high-density fibreboard (HDF), which comprises the wood-based material production device according to the invention. Alternatively, the wood-based material panel production device is a chipboard production device for producing chipboard. Alternatively again, the wood-based material panel production device is an OSB production device for producing coarse chip panels.

The wood fiber panel production device preferably has (a) a boiler for boiling wood chips by means of steam, resulting in boiled wood chips, (b) a refiner, arranged downstream of the boiler in the direction of wood material flow, for defibering the boiled wood chips, resulting in fiber material, and optionally (c) a gluing device, especially a blow line, arranged downstream of the refiner in the direction of wood material flow for gluing the fiber material, resulting in glued fiber material.

The wood fiber panel production device preferably has a scatterer for scattering dried fiber material to form a fiber cake. It is beneficial if the wood fiber panel production device comprises a press, especially a belt press, for pressing the fiber cake to produce a wood fiber panel.

A wood fiber panel refers to a panel that is produced using wood. Preferably, the wood fiber panel has a thickness of between 2 mm and 60 mm. Preferably, a density of the wood fiber panel is between 600 kg per cubic meter and 1000 kg per cubic meter.

Insulating material refers in particular to planar insulating material. It can have a density of between 50 and 400 kg per cubic meter. A thickness of the planar insulating material is preferably between 2 and 800 mm.

A chipboard production device preferably has a scatterer for scattering a fiber cake of glued wood-based material in the form of wood chips to produce a fiber cake and a hot press for pressing the fiber cake to form the chipboard.

An OSB production device or a chipboard production device preferably has a scatterer that is configured to scatter a first surface layer, a middle layer on the first surface layer, and a second surface layer on the middle layer. It is beneficial if the median of the size distribution of the chips of the middle layer is smaller, particularly by at least 15%, than the median of the size distribution of the chips of the first surface layer and/or the second surface layer.

is beneficial if a classifier is arranged upstream of the scatterer in the direction of wood material flow, by means of which wood-based material particles whose size falls outside of a predetermined size range are removed.

### BRIEF DESCRIPTION OF DRAWINGS

In the following, the invention will be explained in more detail with the aid of the accompanying drawings. They show:

FIG. 1 shows a flow diagram of a wood-based material production device according to the invention as part of a wood fiber panel production device according to the invention for carrying out a method according to the invention according to a first embodiment,

FIG. 2 shows a flow diagram of a wood-based material production device according to the invention as part of an OSB production device according to the invention for carrying out a method according to the invention according to a second embodiment,

FIG. 3 shows a flow diagram of a wood-based material production device according to the invention as part of a chipboard production device according to the invention for carrying out a method according to the invention according to a third embodiment and

FIG. 4 shows a flow diagram of a wood-based material production device according to the invention as part of a wood fiber panel production device according to the invention for carrying out a method according to the invention according to a second embodiment.

### DETAILED DESCRIPTION

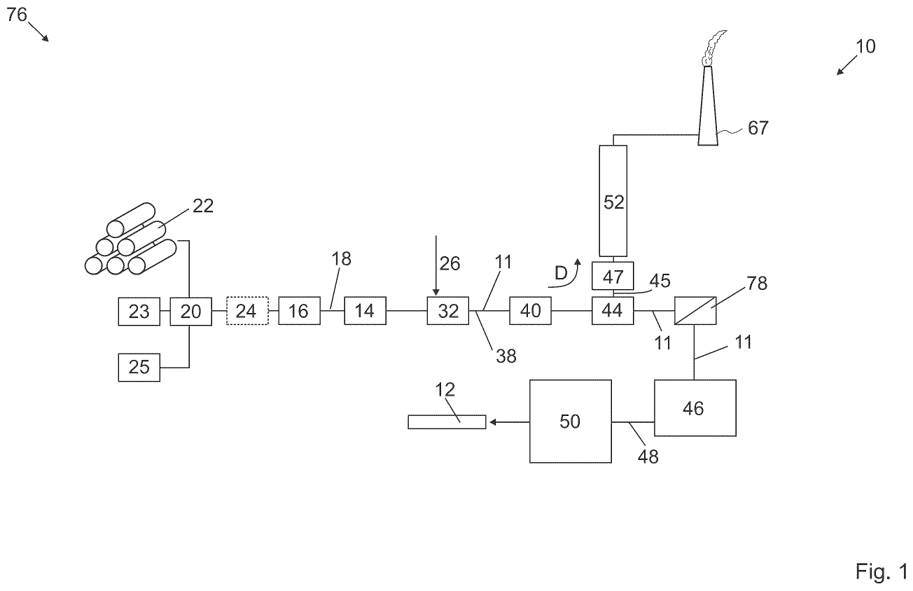

FIG. 1 shows a flow diagram of a wood-based material production device 10 according to the invention for producing wood-based material 11. The wood-based material production device 10 has a boiler 14, which receives wood chips 18 heated by a pre-boiler 16. The wood chips 18 have been purified in the pre-boiler 16, meaning that the pre-boiler 16 has the function of a washing facility. Alternatively, the wood-based material production device may comprise a separate washing facility 24.

A refiner 32 is arranged downstream of the boiler 14 in the direction of wood material flow H, by means of which the wood chips 18 leaving the boiler 14 are defibered.

Together with steam 26, this results in a steam-fiber material mix 38.

The steam-fiber material mix 38 can be fed into a gluing device 40, which is preferably designed as a blow line; this, however, is not essential. The steam-fiber material mix 38 can also be fed to a dryer 44 which exhaust air 45 and dried wood-based material 11 leave; however, the dryer is not essential either. Exhaust air 45 that is produced in the dryer 44. The particle load in the exhaust air 45 can be reduced by means of an optional wet electrostatic precipitator 47.

The wood-based material 11 is used, for example, to produce insulation material, medium-density wood fiber panels (MDF), low-density wood fiber panels (LDF), high-density wood fiber panels (HDF), plant substrate for plant cultivation, for example potting soil, or packaging material.

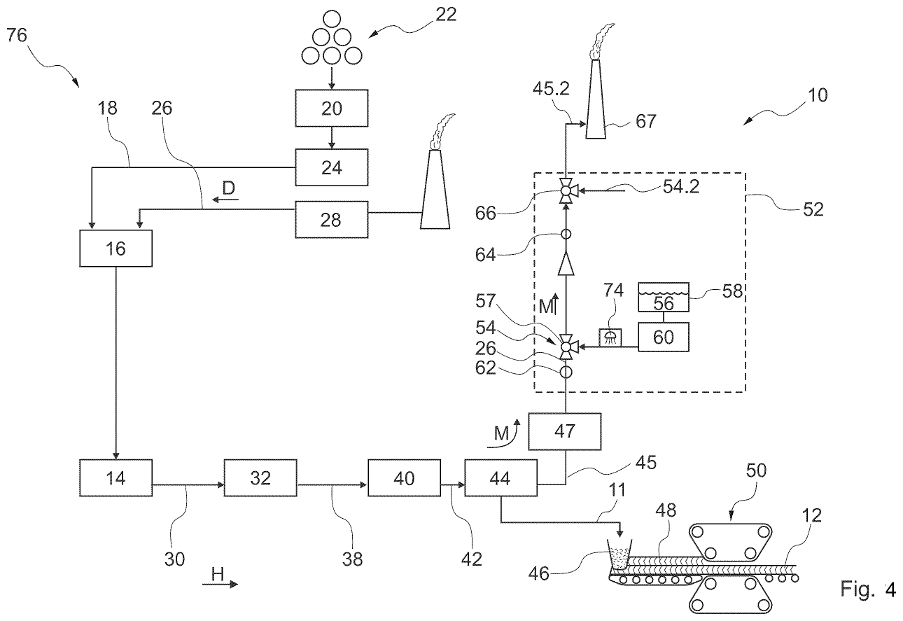

An exhaust air purifier 52 arranged downstream of the dryer 44 and, where applicable, of the wet electrostatic precipitator 47 in the direction of exhaust air flow D reduces the VOC content in the exhaust air 45 before it is introduced into a flue 67 to be released into the environment. The exhaust air purifier 52 is described in detail below in connection with FIG. 4.

The wood-based material production device 10 is part of a wood-based material panel production device 76, in the present case in the form of a wood fiber panel production device. The wood chips 18 can be made from fresh wood 22, fresh wood chips 23 or recycled wood 25 by means of a comminution unit 20.

The wood-based material panel production device 76 has a classifier 78 that removes wood-based material particles which fall outside of a predetermined target size range. A scatterer 46 scatters a fiber cake 48 from the wood-based material 11 and a press 50, especially a hot press, presses it to form a wood fiber panel 12.

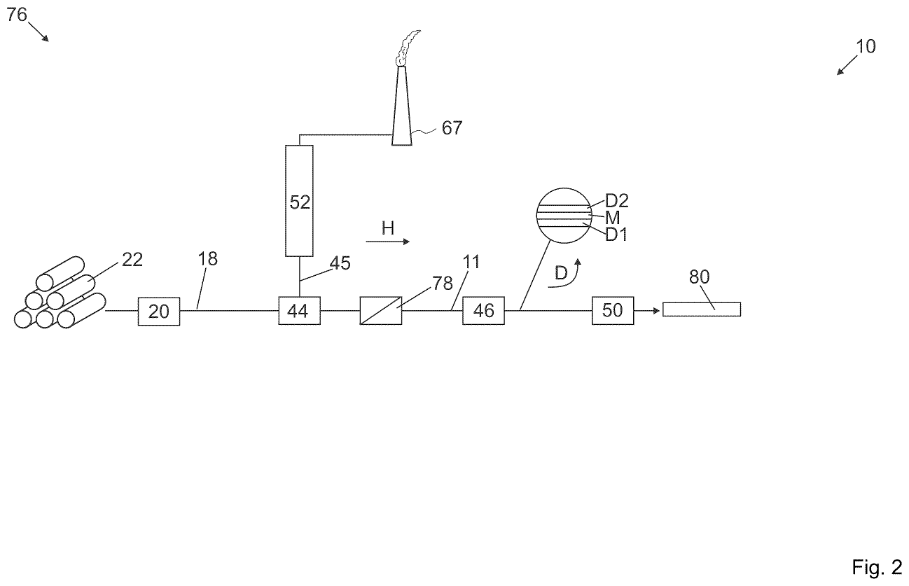

FIG. 2 depicts a second wood-based material production device 10, which constitutes part of a wood-based material panel production device 76 in the form of an OSB production device. The wood chips 18 are produced using the comminution unit 20, for example a chipper, and dried in the dryer 44. The resulting exhaust air 45 is purified by means of the exhaust air purifier 52 described below and then goes into the flue 67.

The classifier 78 and the scatterer 46 are arranged downstream of the dryer 44 in the direction of wood flow H. The classifier 78 classifies the particles of the wood-based material 11 into surface layer particles and middle layer particles. The scatterer 46 scatters a first surface layer D1 of surface layer particles, a middle layer M of middle layer particles on the surface layer D1, and a second surface layer D2 made of surface layer particles on the middle layer M. The layers are pressed by the press 50 to form an OSB 80.

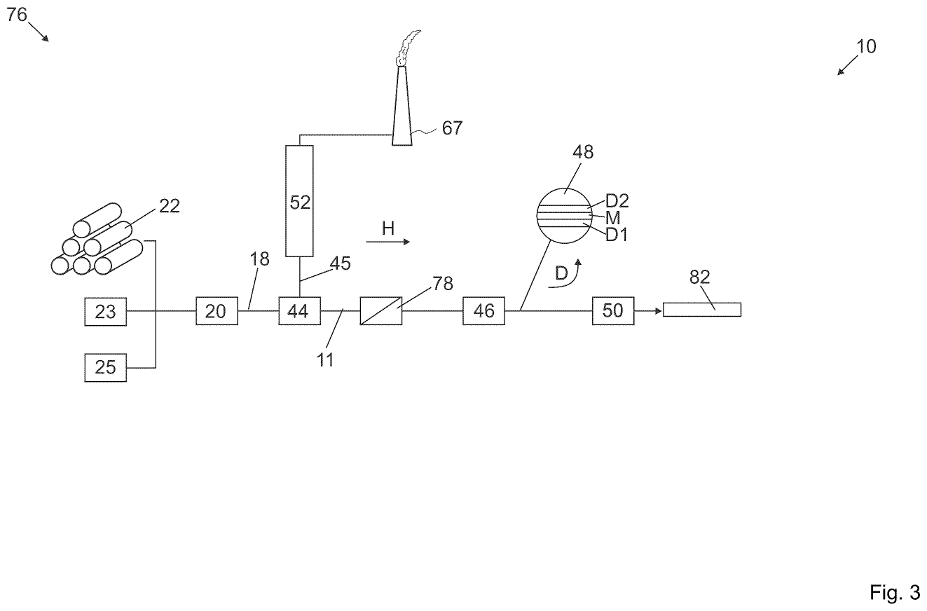

FIG. 3 depicts a third wood-based material production device 10, which constitutes part of a wood-based material panel production device 76 in the form of a chipboard production device for producing a chipboard panel 82. The chips 18 produced by the comminution unit 20 are dried in the dryer 44 and the resulting exhaust air 45 is purified in the exhaust air purifier 52 described below before entering the flue 67.

Downstream of the dryer 44 in the direction of wood flow H, the classifier 78 classifies the particles of the wood-based material 11 into surface layer particles and middle layer particles. The scatterer 46 scatters a fiber cake 48 composed of a first surface layer D1 of surface layer particles, a middle layer of middle layer particles on the first surface layer D1, and a second surface layer D2 of surface layer particles on the middle layer M. The fibre cake 48 is pressed by means of a press 50 to form the chipboard 82.

FIG. 4 depicts a further wood-based material production device 10 according to the invention and a wood-based material panel production device 76 according to the invention. The wood chips 18 produced by the comminution unit 20 are heated in the pre-boiler using steam 26 of a steam generator 28 and then boiled in the boiler 14. They are then defibered in the refiner 32, the steam-fiber mix 38 is glued in the gluing device 40 and then dried in the dryer 44. The exhaust air purifier 52 is arranged downstream of the dryer 44 in the direction of material flow M. Said purifier introduces an oxidizing agent 56 into the exhaust air 45 at an introduction point 54. In the present case, the oxidizing agent is hydrogen peroxide H₂O₂.

The exhaust air purifier 52 comprises an oxidizing agent source 58, which in the present case comprises an oxidizing agent container 58 and a doser 60 in the form of an oxidizing agent pump. Using a VOC concentration gauge 62, the exhaust air purifier 52 measures a first VOC concentration c_{VOC,1} of volatile organic components in the exhaust air 45. Depending on the VOC concentration, an oxidizing agent volume flow Q₅₆ of oxidizing agent 56 is introduced, for example injected, into the exhaust air 45 at the introduction point 54 by means of an introduction device 57. The oxidizing agent 56 reacts with volatile organic components in the exhaust air 45.

The exhaust air purifier 52 may comprise a second VOC concentration gauge 64, which is located downstream of the introduction point 54 in the direction of exhaust air flow D. The second VOC concentration gauge measures a second VOC concentration c_{VOC,2}. In the present case, this refers to the TOC concentration of the overall concentration of organic compounds. If the second VOC concentration c_{VOC,2} is above a specific maximum concentration c_{VOC,max}, the oxidizing agent volume stream Q₅₆ increases.

For example, the maximum concentration corresponds to a predetermined exhaust air limit concentration c_{VOC,BREV} which, for example, is a statutory specification. However, it is also possible that the maximum concentration is lower than the exhaust limit concentration c_{VOC, BREV}. This ensures that the exhaust air limit concentration c_{VOC,BREV} is not exceeded. For example, c_{VOC,max}=f*c_{VOC,BREV} with a safety factor f∈[0.75, . . . , 1]. The smaller the safety factor, the lower the probability that the exhaust air limit concentration c_{VOC,BREV} will be exceeded at any time, but the higher the consumption of oxidizing agent.

The exhaust air purifier 52 regulates the second VOC concentration c_{VOC,2} to a VOC target concentration c_{VOC,soll} by increasing or reducing the oxidizing agent volume flow Q₅₆.

Alternatively, it is possible that the exhaust air purifier 52 comprises an introduction device, such as a nozzle 66, downstream of the second VOC concentration gauge in the direction of exhaust air flow D for introducing oxidizing agent at a second introduction point 54.2. Alternatively, it is possible that the oxidizing agent volume flow Q₅₆ is increased if the second VOC concentration c_{VOC,2} is above the maximum concentration c_{VOC,max}. It is possible, but not essential, for the same oxidizing agent to be introduced at both introduction points 54, 54.2. In particular, it is possible for two different oxidizing agents to be used.

It is also possible that the exhaust air purifier 52 only has one VOC concentration gauge 64 arranged downstream of the introduction point 54 in the direction of steam flow D, wherein oxidizing agent is only introduced into the exhaust air 45 at this one introduction point 54.

The introduction of the oxidizing agent results in purified exhaust air 45.2, which is released into the environment by means of a flue 67.

The exhaust air purifier 52 may comprise a light source 74, by means of which the oxidizing agent 56 can be irradiated with UV light. This results in the formation of hydroxyl radicals that destroy the volatile organic compounds in the branched-off steam 26 especially effectively.

An exhaust air temperature T₄₅ is, for example, 45° C.±5° C. The first VOC concentration gauge 62 measures a first VOC concentration of c_{VOC,1}=200 μg/standard cubic meter, for example. The oxidizing agent volume flow is then adjusted to Q₅₆=50 liter/hour, for example. In this case, the oxidizing agent 56 is a 5% (percent by weight) hydrogen peroxide solution. The second VOC concentration gauge 64 then measures a second VOC concentration of c_{VOC,2}=c_{TOC,2}=30 μg/standard cubic meter. A standard cubic meter is the amount of gas that takes up 1 cubic meter under standard conditions of 1013 hPa and 23° C.

The wood-based material production device 10 may be part of a wood-based material panel production device 76, which comprises a scatterer 46 for scattering glued wood-based material 11 on a transport belt, resulting in a fiber cake 48. The fiber cake 48 is pressed to produce a wood fiber panel 12 using a press 50.

1. A method for producing a wood-based material in which exhaust air is produced which contains volatile organic substances in form of terpenes, and which is released into the environment, comprising introducing an oxidizing agent into the exhaust air, and causing terpenes contained in the exhaust air to be oxidized, resulting in purified exhaust air.

2. The method according to claim 1, further comprising:
(a) measuring a VOC concentration of volatile organic compounds in the form of terpenes in the exhaust air; and
(b) controlling the introduction of the oxidizing agent into the exhaust air on a basis of the VOC concentration.

3. The method according to claim 2, wherein the controlling the introduction of the oxidizing agent into the exhaust air on the basis of the VOC concentration comprises:
(a) comparing the VOC concentration with a limit concentration,
(b) introducing an idle flow of oxidizing agent, in particular no oxidizing agent, if the VOC concentration falls below the limit concentration, and
(c) if the VOC concentration does not fall below the limit concentration, introducing an oxidizing agent flow that is selected in such a way that a release VOC concentration in the exhaust air, which is released into the environment, is below a predetermined exhaust air limit concentration.

4. The method according claim 2, further comprising:
(a) continuously measuring a second VOC concentration of volatile organic compounds in the form of terpenes, in the exhaust air downstream of an introduction point in a direction of steam flow where the oxidizing agent is introduced into the exhaust air, and
(b) controlling the introduction of the oxidizing agent into the exhaust air on a basis of the second VOC concentration.

5. The method according to claim 1, further comprising irradiating the oxidizing agent with UV light such that the oxidizing agent forms radicals.

6. The method according to claim 1, wherein
(a) the volatile organic compounds react directly, in an uncatalysed manner, with the oxidizing agent, and/or
(b) the oxidizing agent is not molecular oxygen; wherein it is not atmospheric oxygen.

7. The method according to claim 1, wherein the oxidizing agent is introduced into the exhaust air in such a way that oxidation products resulting from the oxidation of the volatile organic compounds in the exhaust air are released into the exhaust air.

8. The method according claim 1, wherein the oxidizing agent is introduced into the exhaust air in such a way that the terpenes are oxidized in the gas phase.

9. The method according to claim 1, further comprising:
(a) heating wood chips in a pre-boiler by means of water or steam,
(b) then boiling the wood chips in a boiler by means of steam, and
(c) subsequently defibering the wood chips in a refiner, resulting in fiber material.

10. The method according to claim 1, wherein the wood-based material is a wood fiber material and the wood fiber material is further processed to produce insulating material, plant substrate for plant cultivation, a medium-density fiber panel, a high-density fiber panel or packaging material from the fiber material.

11. The method according to claim 1, wherein
(a) the wood-based material is wood chips and the method comprises:
(i) chipping round timber, wood residues and/or waste wood, resulting in wood chips,
(ii) drying the wood chips,
(iii) gluing the wood chips,
(iv) scattering the glued wood chips and molding them to create a chip mat. and
(v) pressing the chip mat to produce the chipboard, or
(b) the wood-based material is coarse chips and the method comprises:
(i) chipping round timber, wood residues, waste wood, resulting in coarse chips,
(ii) drying the coarse chips,
(iii) gluing the coarse chips,
(iv) scattering the glued coarse chips to produce a chip mat and pressing the chip mat to form an OSB panel.

12. A wood-based material production device for producing a wood-based material comprising:
(a) a comminution unit for comminuting wood,
(b) a dryer for drying comminuted wood, producing exhaust air that contains volatile organic substances in the form of terpenes, characterized by
(c) an exhaust air purifier that is configured to introduce an oxidizing agent into the exhaust air, causing volatile organic compounds contained in the exhaust air to be oxidized and resulting in purified exhaust air.

13. The wood-based material production device according to claim 12, wherein:
(a) a VOC concentration gauge for measuring a VOC concentration of volatile organic compounds in the form of terpenes, in the exhaust air upstream of an introduction point in the direction of exhaust air flow where the oxidizing agent is introduced into the exhaust air, and
(b) a doser that is designed to automatically introduce the oxidizing agent into the exhaust air on the basis of the VOC concentration.

14. The wood-based material production device according to claim 13, wherein:
(a) a second VOC concentration gauge for measuring a second VOC concentration in the exhaust air downstream of the introduction point in the direction of exhaust air flow,
(b) wherein the doser is designed to automatically introduce the oxidizing agent into the exhaust air on the basis of the first VOC concentration and the second VOC concentration.

15. The wood-based material production device according to claim 14, wherein an introduction device that is designed to automatically introduce the oxidizing agent into the exhaust air at a second introduction point that is located downstream in the direction of exhaust air flow from where the second VOC concentration is measured.

16. The wood fiber material production device according to claim 12, wherein:
(a) a gluing device, especially a blow line, arranged downstream of the refiner in the direction of wood material flow for gluing the fiber material, resulting in glued fiber material,
(b) a dryer arranged downstream of the gluing device in the direction of wood material flow for drying the glued fiber material,
(c) a scatterer for scattering dried fiber material to produce a fiber cake and
(d) a press, especially a belt press, for pressing the fiber cake to form a wood fiber panel.
